(19) United States
(12) Patent Application Publication
(10) Pub. No.: US 2005/0078730 A1
(43) Pub. Date: Apr. 14, 2005

(54) Optimizing power for second laser

(76) Inventors: Kevin Holsinger, Menlo Park, CA (US); John Phillip Ekstrand, Palo Alto, CA (US); Richard Boggy, Sunnyvale, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/952,545

(22) Filed: Sep. 27, 2004

Related U.S. Application Data
(63) Continuation-in-part of application No. 10/301,502, filed on Nov. 20, 2002, now abandoned.
(60) Provisional application No. 60/331,967, filed on Nov. 20, 2001.

(51) Int. Cl. H01S 3/091

(52) U.S. Cl. 372/70; 372/99

(57) ABSTRACT

Feedback from a power monitor sampling a portion of the output beam of a cavity is used to control the position of a pump beam relative to the cavity. The pump beam position or orientation is adjusted in response to a dither signal imposed on the position or tilt of an external optic or mirror in order to maximize the efficiency of the cavity in converting pump power to output power. Feedback based on the response of the power monitor may be used to control the position or tilt of the mirror or optic to which the dither was applied.

### CROSS-REFERENCE TO RELATED APPLICATIONS

This application is a continuation-in-part of U.S. Ser. No. 10/301,502 filed Nov. 20, 2002, which claims the benefit of U.S. Ser. No. 60/331,967, filed Nov. 20, 2001. All applications listed above are fully incorporated herein by reference for all purposes.

### BACKGROUND

1. Field of the Invention

The present invention is directed to an optical system with a cavity pumped by a pump source, and more particularly to an optical system where an efficiency of the cavity is maximized by adjusting a position of the pump beam relative to the cavity.

2. Description of the Related Art

In recent years, medical and industrial applications using laser systems have proliferated. As the lasers have become more reliable and commonplace, there has also been a greater emphasis on improving control of the laser parameters in order to improve outcomes in practical settings. Providing the required controls presents a greater challenge as increasingly complex laser systems are being introduced into applications which place stringent demands on performance and operating lifetime even though the preferred devices are required to be more compact and cost effective. Ultra-fast lasers, build-up cavities involving resonant frequency doubling, systems including optical parametric conversion devices and multiple harmonic modules and high power fiber lasers are all examples of complex laser systems requiring sophisticated controls to perform their intended functions.

Ultrashort pulse lasers have, in particular, been promoted as an effective new tool for a variety of medical and industrial applications, and especially where small interactions zones, fine feature sizes and limited collateral damage are considered highly beneficial. Examples include metrology measurements, two-photon microscopy, material processing, stereolithography and corneal sculpting procedures. In the case of material processing applications ultrafast lasers exploit localized laser induced breakdown mechanisms to provide submicron processing capability. Some applications exploit the ability of ultrafast lasers to ablate surface regions that are even smaller than their minimum, diffraction-limited, spot size. Many micro-machining, inscription, and hole drilling procedures have been proposed that take advantage of the high degree of precision provided by ultrafast interactions. Examples include drilling holes with sub-wavelength pitch to produce photonic crystals as described in U.S. Pat. No. 6,433,305, removal of biological and other types of material while incurrring minimal collateral damage and attaining greatly increased cut quality, as taught in U.S. Pat. No. 5,720,894, precise surface ablation in either opaque or transparent materials as described in U.S. Pat. No. 5,656,186 and U.S. Pat. No. 6,333,485, and inscription of micro patterns in various materials.

Note is taken of the fact that the efficacy of micro-machining procedures carried out with ultrashort pulse lasers depends in a large measure on the precision of controls provided by the system of the key output laser parameters including power, pulse energy and/or pulse width. In particular, controlling and stabilizing the output power are essential to the precision with which micro-holes can be drilled, micro-patterns can be inscribed or clean repeatable cuts can be made. Procedure repeatability and high throughputs are especially important considerations for virtually all industrial, biological and surgical applications which contemplate the use of ultrafast lasers.

Another especially good example of an application requiring a high degree of control is provided by emerging metrology applications such as the ultrasonic short pulse technique successfully developed into a semiconductor inspection tool. The technique, described in U.S. Pat. No. 5,959,735 (Optical stress generator and detector) and U.S. Pat. No. 5,748,317 (Apparatus and method for characterizing thin film and interfaces using an optical heat generator and detector), both by Maris et al, uses femtosecond laser pulses to produce ultrasonic echoes which are analysed to derive the thickness of single or multi-layer metal films used in integrated circuit manufacturing. With metal layers ranging from under 20 Å to over 5 μm, high precisions with better than 1-2% repeatability are required along with high throughput rates. Precise control of key laser parameters is therefore essential for this application. In particular, variations in power can contribute to nonuniformities in thickness measurements which can compromise the measurements.

In many of foregoing applications, it is required that the laser be capable of hands-off reliable operation for prolonged periods of time in an industrial or medical setting. At the same time during the time the output laser beam is coupled to a work piece, the laser must provide power levels and other operational characteristics that are as constant as possible and be free of long term drift or unpredictable power instabilities. Generally, it is known that uncontrolled fluctuations in power or other laser parameters such as the pulse width, wavelength or beam divergence lower the accuracy of the laser interactions with a target material and compromise the system performance. Whereas methods of stabilizing operating laser parameters are known in the art, many such techniques require numerous additional components and are too complex to implement in an industrial setting especially where reliable throughputs and space considerations are paramount. It is therefore highly desirable to provide a laser system with improved reliability and stabilized output control features on a fine scale using the most expedient and cost effective means.

Typically, the more complex laser systems that are the subject of the present invention comprise at least two or more key subsystems, each of which may be a laser cavity or optical system. In this case changing parameters of an output beam which is the one delivered to the target requires controlling an existing input system or subsystem with its own fully designed control electronics and drivers.

For example, the pump laser may comprise a commercially designed diode pumped green laser used to drive a tunable IR laser such as a Ti:sapphire laser designed to provide ultrashort pulses. Alternatively the tunable laser may comprise an optical parametric converter or a Raman shifter to provide a fixed set of wavelengths. In still other examples the optical system may include build up cavities for resonant harmonic conversion or an injection seeded amplifier in a MOPA configuration.

Control of a pump beam into a second laser is the subject of U.S. Pat. No. 4,514,849 (Dye Laser with Rotating Wedge Alignment Servo), by Witte et al. They describe a servo system in which a rotating wedge is used to produce a movement of a pump beam into a second laser, with the movement defining a conical surface. The resultant modulation of the power of the second laser is used to create a feedback control to a motor-driven mirror to direct the beam to a spot in the second laser that maximizes the output power. The use of the rotating wedge approach has several disadvantages. The wedge is fixed, such that the amplitude of the dither cannot be adjusted. The final alignment can only be an average of the positions of the pump beam as it traces a circular path in the gain medium while it is driven by the feedback loop toward the position that produces maximum power. As a result, the pump beam can never pass through the position of best alignment while the dither is in process, because the best it can do is to continue to circle it. Witte et al used the error signal induced by rotating the wedge to control the angular tilt of a motor-driven mirror. This method requires that at least two optical elements must undergo mechanical motion. The Witte system neither teaches nor suggests dithering the positioning mirror to be aligned, which would reduce the number of moving optical elements to one.

In U.S. Pat. No. 5,033,061 (Laser alignment servo method and apparatus), Hobart et al apply the concept of dithering the angular alignment of an intracavity mirror to optimizing the performance of the laser using feedback to adjust the alignment of the same mirror. In this case the dithered optic is part of the laser for which power is being maximized rather than being an external optic that is optimizing the position or orientation of a pump beam. There will always be some resultant modulation of the output power, which means that there will be some induced noise at the dither frequency. One way to minimize the noise contribution is to use the error signal to maximize pumping efficiency while holding the output power fixed.

In all of these cases, controlling and adjusting the output power of a laser consisting of one or more complex subsystems can be a major issue. There is therefore a need for techniques that can provide a high degree of control of selected properties of the output from optical systems that may include one or more laser subsystems. There is a particular need for cost effective techniques that provide a means of compensating for misalignment that can degrade system performance in an industrial environment. There is further a need to be able to make these adjustments in a way that enhances system reliability and extends system lifetime in medical and industrial applications. This invention not only provides an important tool for meeting these criteria, but also makes possible extended operation of a complex optical system without need for frequent maintenance. The system can remain enclosed for greatly extended periods of operation, meaning that it is less likely to be adversely affected by an industrial environment.

### SUMMARY

Accordingly, one embodiment of this invention utilizes movement of a mirror or other suitable optical element external to a second cavity in order to achieve efficient pumping of the second cavity and optimize the output of a beam generated by this second cavity by using feedback from an external power monitor that samples a portion of the output beam thereby adjusting the movement of the optical element. In one embodiment of the present invention, the movement of the mirror or optic comprises a dither that affects the position of a pump beam incident on the second cavity.

It is therefore an object of the present invention is to provide an optical system that includes a cavity pumped by a pump source, and producing an output beam wherein the efficiency of the cavity is improved.

A further object of the present invention is to provide an optical system with a cavity pumped by a pump source that maximizes the power of the output beam from the cavity.

It is yet another object of the invention to optimize the efficiency of the cavity or maximize the output power by means that are simple, can be electrically controlled and cause little or no additional noise.

These and other objects of the present invention are achieved in an optical system with a pump source that produces a first output beam. A cavity is pumped by the first output beam and produces a second output beam. A power monitor is positioned to receive at least a portion of the second output beam. In response to a signal from the power monitor the efficiency of the cavity is maximized by adjusting a position of the first output beam relative to the cavity. Alternatively the power output of the cavity can be maximized by adjusting the position of the pump beam relative to the cavity.

In another embodiment of the present invention, an optical system has a pump source that produces a first output beam. A cavity is pumped by the first output beam and produces a second output beam. A first power monitor is positioned to receive at least a portion of the second output beam. The first power monitor provides an input to a summing junction coupled to the pump source. In response to a signal from the power monitor, an efficiency of the cavity is maximized by adjusting a position of the first output beam relative to the cavity.

A further understanding of the nature and advantages of the invention will become apparent by reference to the remaining portions of the specification and drawings.

### BRIEF DESCRIPTION OF THE DRAWINGS

FIG. 1 is a box diagram illustrating the key elements of the optical system addressed by the present invention.

FIG. 2 illustrates schematically the effect of dither of the pump mirror on the position of the pump beam of FIG. 1.

FIGS. 3a-3c illustrate one embodiment of the spatial beam profiles of the pump beam and the cavity mode relative to each other (side view), wherein FIG. 3a specifically shows the standard profiles corresponding to a stationary pump mirror with the cavity mode enclosed within pump mode more or less symmetrically; FIG. 3b illustrates the shift of the pump beam profile relative to the cavity mode upon displacement of the pump beam profile; and FIG. 3c is a more extreme case showing the large offset of pump mode relative to the cavity mode.

FIGS. 4a-4c illustrate the cross sections of the pump spot relative to the cavity spot size corresponding to the cases shown in FIG. 3, wherein FIG. 4a shows a stationary pump mirror—no dither; FIG. 4b shows offset of beam cross sections upon deviation from mode matching; and FIG. 4c shows offset of the beam cross sections upon extreme deviation from optimal mode matching.

### DETAILED DESCRIPTION OF THE EMBODIMENTS

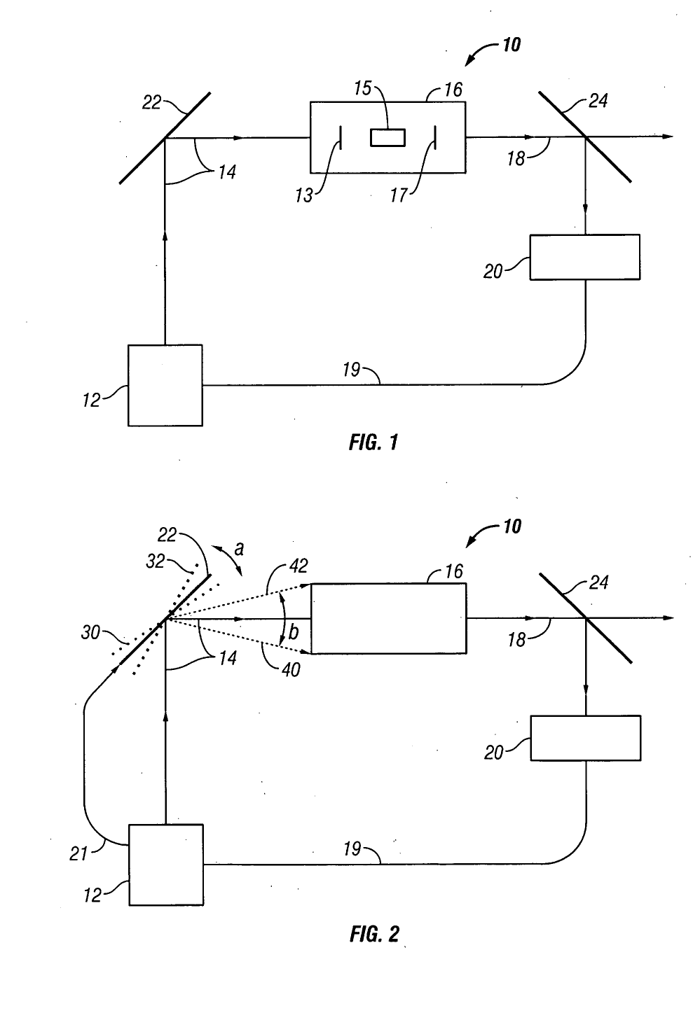

In one embodiment of the present invention, illustrated in FIG. 1, an optical system 10 has a pump source 12 that produces a first output beam 14. The first output beam 14 is reflected from a reflector 22 which is positioned between pump source 12 and cavity 16 in order to direct first output beam 14 into cavity 16. In the remainder of this patent, first output beam 14 may be interchangeably referred to also as pump beam 14. In one embodiment, cavity 16 comprises at least an input mirror 13 an output mirror 17 and a gain element 15. When pumped by beam 14, cavity 16 produces a second output beam 18A beam splitter 24 positioned along a beam path of second output beam 18 can be included in the optical system 10. Beam splitter 24 directs at least a portion of second output beam 18 to power monitor 20.

In one embodiment, the position of beam 14 can be adjusted relative to cavity 16. The adjustment may be selected such that the power of second beam 18 is maximized in response to a signal 19 from power monitor 20. Alternatively, the adjustment may be selected to optimize the output efficiency of cavity 16 by reducing the power requirements on pump power 14. The output efficiency of cavity 16 is herein defined as the ratio of the power of second output beam 18 to the power of first output beam 14.

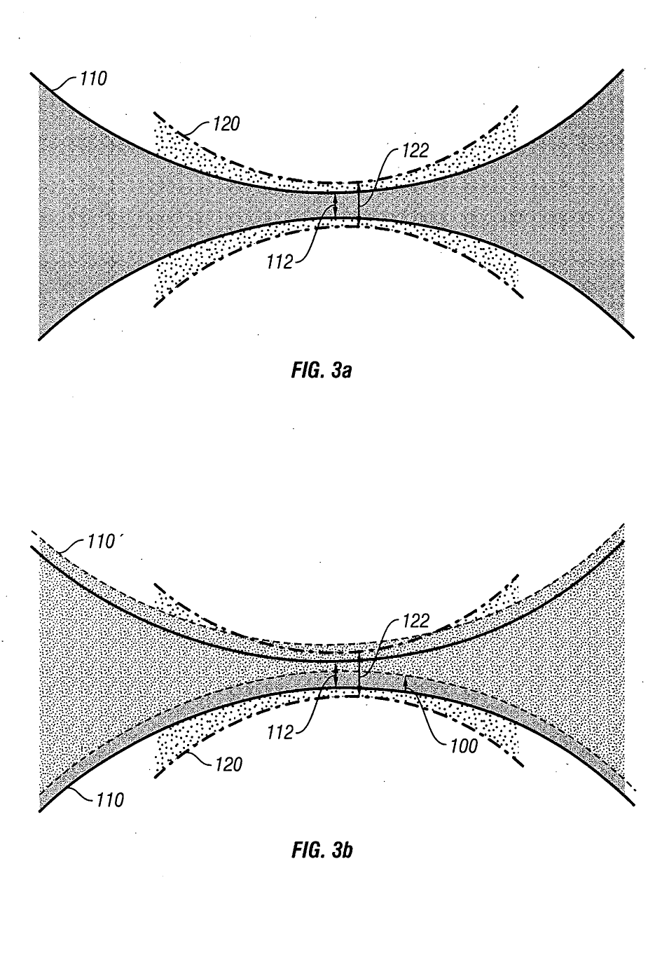

Referring now to FIG. 2 one embodiment of the technique used to adjust position of incidence of beam 14 on cavity 16 is shown. In this embodiment, reflector 22 which may be movably mounted, can be dithered in response to commands issued by signal 21. In the embodiment as shown in FIG. 2, signal 21 is shown as provided by pump source 12 which can contain one or more circuit boards configured to respond to command signal 19 issued by power monitor 20. In this manner the response of second output beam 18 to the dithering of reflector 22 can be used to determine orientations of the reflector which maximize power of second output beam 18. The response of second output beam 18 can also be used to minimize power requirements of first output beam 14 while maintaining the same power of second beam 18 to thereby increase the efficiency of cavity 16, as was described above.

It should be understood that alternative embodiments of the circuitry used to provide feed-back to reflector 22 in response to power measurements by monitor 20 all fall within the scope of the invention. For example, embodiments may be utilized wherein commands are issued to reflector 22 directly from power monitor 20, bypassing pump source 12. Such embodiments may be useful in cases where the power of output beam 18 is to be maximized, without altering the pump power delivered by output beam 14. Generally, the commands 21 are provided to actuator or transducer means (not shown in FIG. 2) incorporated within reflector 22 which control its motion. The dither can be applied in each of two orthogonal directions (X and Y) and the amplitude of the dither can be adjusted electronically to minimize the introduction of noise in the output of the pumped laser.

The movement of the reflector 22 as well as the applied dither motion can be made using a variety of transducers, such as piezoelectric devices, stepper motors, DC motors, and electromagnetic transducers. The movement of the optic in response to the feedback can be made using the same transducers that apply the dither motion or by a different transducer. The transducer means may comprise, in one example, one or more PZT (piezoelectric) stacks affixed to the mirror which cause it to move in response to commands delivered by signal 21. In another example, the motion of the reflector may be driven by small motors which contain circuitry responsive to signals 21.

Movement of the optic along orthogonal directions can be made by using the same or different transducers. Furthermore, the dither motion applied to the reflector along orthogonal directions can be made with the same or different transducers. Simplicity is best served by using the same transducer type for all movements of the optic, such as an arrangement of two or more piezoelectric stacks that can supply many microns of motion with an applied voltage of below one hundred volts. The choice of one or two-dimensional dither depends on the details of optical system 10, the type of optical cavity 16 and overall system requirements, including power, efficiency and lifetime.

In FIG. 2, one embodiment of reflector 22 is shown to be tiltable over a range of angles. A clockwise rotation can tilt reflector 22 to position 30 to cause pump beam 14 to be deflected along path 40. Likewise, a counterclockwise rotation can tilt reflector 22 to position 32 to cause pump beam 14 to be deflected along path 42. It is to be noted that the rotation angle a and deflection angle b indicated in FIG. 2 have been exaggerated for purpose of illustration. Generally, and in keeping with notation commonly used in the art, the rotation of reflector 22 is referred to as a dither when the rotation is oscillatory over a small angular range.

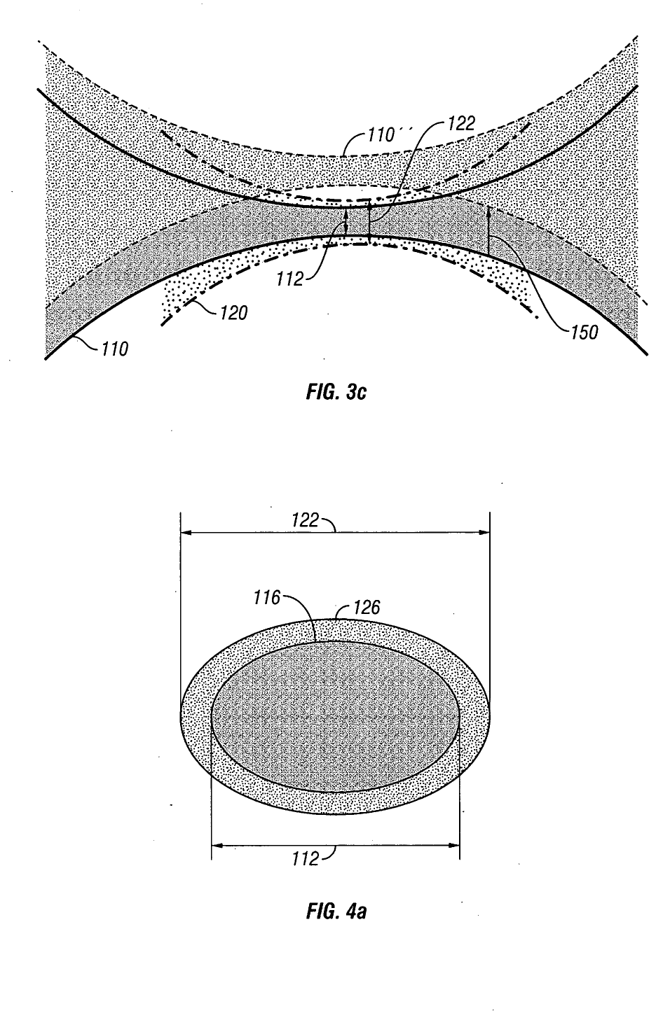

FIG. 3a shows one embodiment corresponding to profile 120 of the transverse mode of cavity 16 and profile 110 of pump beam 14. This mode matching configuration corresponds to a case of a maximum overlap of the pump mode and the intracavity mode and is known to result in optimal transfer of energy from the pump mode to the cavity mode. It is provided for illustration purposes as other mode matching configurations may be selected, depending on the details of cavity 16, and are not meant to be excluded from the present invention. In FIG. 3a, beam waist diameter 122 corresponds to cavity mode profile 120 and beam waist diameter 112 corresponds to that of the beam mode profile 110 of pump beam 14. In this example, 122 is shown as larger than 112, but, as noted above the following discussion will apply to other situations where the relative sizes of the beam diameters are the same or are even reversed.

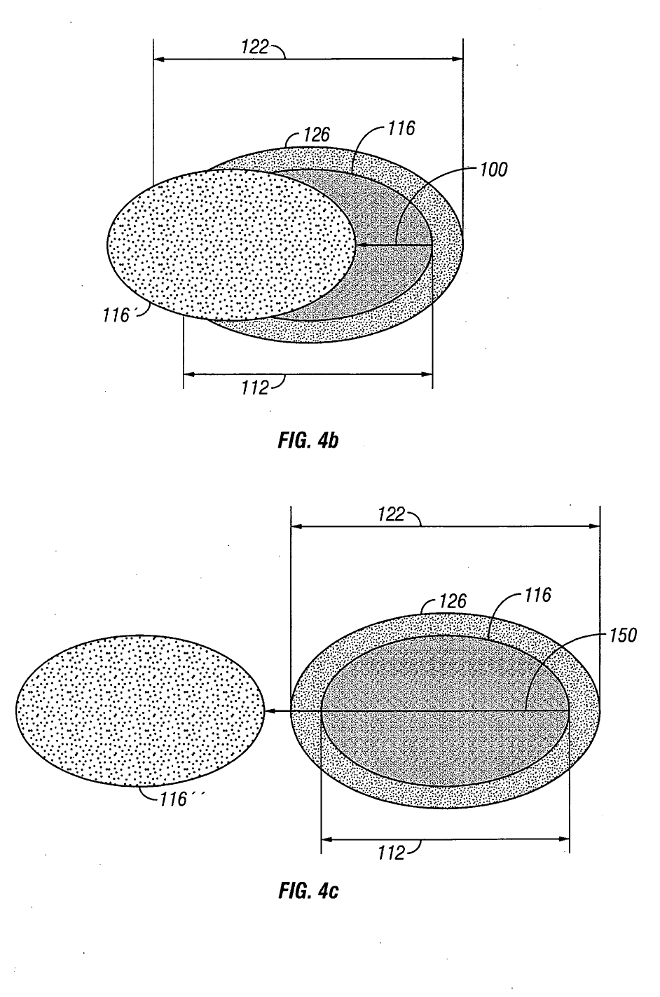

FIG. 4a is a view of the cross-sections of the transverse modes for both the pump beam and the cavity near their beam waist positions corresponding to a side view of FIG. 3a. This figure illustrates the optimal mode matching conditions wherein the cross-section 116 of the pump beam is centered on cross-section 126 of the cavity mode. As mentioned above, this illustrates the case of optimal efficiency of energy transfer. Note that the beams shown in this case have cross sections that are somewhat elliptical. For convenience, the spot diameters referred to in FIG. 3a (112 and 122) correspond to the major axis diameter of the ellipse.

FIG. 3b indicates an offset of the beam profiles upon displacement of pump beam mode profile 110 by a transverse offset 100 relative to the cavity mode profile to a new position indicated by pump beam mode profile 110′, such displacement occurring in response to a movement of pump beam 14 due to undesirable environmental, cavity or pump beam changes. The offset 100 results in non-optimal overlap of pump beam profile 110′ with cavity mode profile 120, which is shown as generally a fixed property of cavity 16 design, unless moved due to cavity misalignment. The result is that the efficiency of energy transfer from pump beam 14 to cavity mode 120 of cavity 16 is reduced, thereby reducing the power of output beam 18.

FIG. 4b is the corresponding cross-sectional view of the modes shown in profile view in FIG. 3b, in which the pump mode is shifted by a transverse offset 100 relative to the cavity mode. The pump mode cross-section 116 is shown as shifted to location 116′ and the overlap of the shifted pump cross-section 116′ with the cavity mode cross-section 126 is now illustrated as only partial, resulting in diminished efficiency of energy transfer from the pump to the cavity 16 and therefore to the output beam 18.

FIG. 3c indicates a more extreme displacement of pump beam mode profile 110 by a transverse offset 150 to a new position indicated by pump beam mode profile 110″ The offset 150 results in highly non-optimal overlap of pump beam profile 110″ with cavity mode profile 120, which, again, is fixed within cavity 16. In FIG. 3c, the beam waists of pump mode profile 110″ and cavity mode profile 120 have virtually no overlap, resulting in a drastically reduced efficiency of energy transfer from pump beam 14 to the cavity mode 120 of cavity 16 and therefore to substantial decrease in the power of output beam 18.

FIG. 4c is the corresponding cross-sectional view of the mode profile of FIG. 3c, in which the pump mode is shifted by a large transverse offset 150 relative to the cavity mode, illustrating the adverse conditions where there is virtually no overlap of the shifted pump cross-section 116″ with the cavity mode cross-section 126. It is not surprising that in such a case, poor mode matching will result in drastically diminished efficiency of energy transfer between pump and cavity modes.

To counter the undesirable changes in the optimal overlap conditions for the pump beam and the cavity mode, deliberate dithering of the overlap of the pump mode relative to the fixed cavity mode results in a modulation of the efficiency of energy transfer from the pump mode to the cavity mode, and the amount of modulation can then be used as an error signal for the purpose of driving the tilt of reflector 22 to optimize the mode overlap of pump and cavity modes (in the direction of the dither) to thereby compensate for deviations from optimal mode matching. Note that although the dithering process itself produces an offset in the pump profiles as was shown in FIGS. 3b and 4b (in this case, the beam waist diameters 112 of the pump beam and 122 of the cavity mode represent the diameters of the beam waists along the direction of deflection of reflector 22) the amount of offset due to dither is very small and does not result in any substantial reductions to the cavity efficiency and/or the power contained in the second output beam generated by the cavity. Note that the magnitudes of the reflector 22 deflection shown in FIG. 2, as well as the corresponding displacements of the beam profiles seen in FIGS. 3b and 4b are in this case, considerably exaggerated.

It is noted that in the foregoing discussions, we have limited the figures and the discussion to the two-dimensional case, with dither being applied about a single axis in the interests of simplicity. It is to be understood however, that similar descriptions and pictures provided for illustration of the concepts disclosed in this invention, can applied also to the orthogonal direction, such that the mode overlaps can be optimized with the pump mode centered on the cavity mode in both orthogonal axes transverse to the pump beam propagation direction. Thus, while orthogonality may not be a requirement of the system constructed according to this invention, it may represent a more efficient manner of implementation in practice.

Methods and techniques addressed in this disclosure apply to a variety of of optical systems including optically pumped lasers and frequency conversion systems such as harmonic generators, optically parametric oscillators (OPO's) and Raman converters as well as a variety of build-up and/or resonant cavities (including storage cavities). Pump source 12 can include a gain medium including but not limited to materials such as Nd:YVO₄, Nd:YAG, Nd:YLF, Nd:Glass, Ti:sapphire, Cr:YAG, Cr:Forsterite, Yb:YAG, Yb:KGW, Yb:KYW, Yb:glass, KYbW and YbAG. In one embodiment, the gain medium is pumped by diodes or diode laser arrays and may be frequency converted—internally or externally—by a nonlinear material such as LBO, KTP or KNbO3 to second or higher harmonics. Cavity 16 can thus represent a variety of devices including but not limited to a Ti:sapphire laser, an OPO, a build-up cavity, a non-linear device such as a Raman converter or a harmonic generator including a frequency doubler and the like. The build up cavity can also include non-linear optical components.

Furthermore, one or both of pump source 12 or cavity 16 can include a Q-switching or mode-locking device. Suitable Q-switches include active and passive modulators. Suitable mode-locking devices include but are not limited to, a multiple quantum well saturable absorber, a non-linear mirror mode locker, a polarization coupled mode locker, an acousto-optic modulator, and the like. One particular example of an embodiment of cavity 16 that can benefit from the methods of the present invention, is a resonator cavity designed to produce an output beam with selected spectral components as was described in co-pending U.S. patent application Ser. No. 10/301,503, incorporated by reference herein. In this embodiment, cavity 16 includes one or more dispersion elements such as prism or grating pairs as well as apertures and a variety of optical elements such as beam splitters, in addition to gain medium and resonator optics.

It is further noted that in FIGS. 3 and 4, the pump beam waist and the cavity beam waist were illustrated as being in close proximity, a prerequisite for efficient energy conversion from the pump beam to the cavity output beam. In an optically-pumped laser, including, but not limited to a green laser pumped Ti:sapphire laser, the overlap of the cavity mode volume and the pump mode volume in the vicinity of their beam waists is normally within the gain medium, where the transfer of energy is moderated by the medium. Similarly, in an optical parametric oscillator, the overlap normally occurs within a non-linear crystal, where the transfer of energy from pump mode to cavity mode takes place. By contrast, in coupling of the pump beam to a build-up (or storage) cavity, the mode-coupling of the pump mode to the cavity mode is critical to energy storage in the cavity, but the overlap of modes does not necessarily occur in a gain medium nor in a non-linear crystal. In all cases addressed so far, use of this invention provides advantages for system stability against misalignment that might result from changes of environmental conditions such as temperature changes or from drifts in alignment of optical components. In addition, changes of beam pointing in the pump laser that might result from thermal effects can be compensated by the automated adjustment of the controlled mirror or optic. As a result, use of the dithering technique results in extended reliability and lifetime enhancement for the second output beam, whether generated by a second laser, nonlinear device or build-up cavity.

While the invention has been described in connection with what is presently considered to be the most practical and preferred embodiment, it is to be understood that the invention is not limited to the disclosed embodiment, but on the contrary it is intended to cover various modifications and equivalent arrangement included within the spirit and scope of the claims which follow.

1. An optical system, comprising:
a pump source that produces a first output beam;
a cavity pumped by the first output beam and producing a second output beam;
a movably mounted reflector positioned between the pump source and the cavity to direct the first output beam into the cavity; and
a power monitor positioned to receive at least a portion of the second output beam, wherein in response to a signal from the power monitor an efficiency of the cavity is maximized by dithering the reflector to thereby cause adjustment of a position of the first output beam relative to the cavity.

2. The system of claim 1, wherein a response of the second output beam to dithering of the reflector is used to determine a reflector orientation which maximizes power of the second output beam.

3. The system of claim 1, wherein a response of the second output beam to dithering of the reflector is used to determine a reflector orientation to maximize the efficiency of the cavity.

4. The system of claim 1, further comprising:
a beam splitter positioned along a beam path of the second output beam, the beam splitter directing the at least a portion of the second output beam to the power monitor.

5. The system of claim 1 wherein the power of second output beam is maximized by optimizing mode matching between first output beam and the cavity mode.

6. The system of claim 1 wherein the efficiency of the cavity is maximized by optimizing mode matching between first output beam and the cavity mode.

7. The system of claim 1, wherein the signal is used to maintain constant power of the second output beam

8. The system of claim 1, wherein the pump source is an optically pumped laser.

9. The system of claim 1, wherein the pump source is a diode laser, a diode laser array or a fiber coupled diode.

10. The system of claim 1, wherein the pump source has a gain medium selected from Nd:YVO₄, Nd:YAG, Nd:YLF, Nd:Glass, Ti:sapphire, Cr:YAG, Cr:Forsterite, Yb:YAG, Yb:KGW, Yb:KYW, Yb:glass, KYbW and YbAG.

11. The system of claim 1, wherein at least one of the pump source or the cavity includes a mode locking device.

12. The system of claim 1, wherein the pump source includes a second harmonic generator.

13. The system of claim 1, wherein the cavity is an OPO.

14. The system of claim 1, wherein the cavity is a build up cavity.

15. The system of claim 14, wherein the build up cavity includes non-linear optical components.

16. The system of claim 1, wherein the cavity is a Ti:sapphire laser.

17. The system of claim 1, wherein the cavity is a non-linear device.

18. The device of claim 1, wherein the cavity is a frequency doubler.

19. The system of claim 1, wherein the cavity comprises:
an end mirror and an output coupler defining a resonator cavity; and
a gain medium positioned in the resonator cavity.
